(19) United States
(12) Patent Application Publication
(10) Pub. No.: US 2005/0076224 A1
(43) Pub. Date: Apr. 7, 2005

(54) Coding system

(76) Inventor: George R. Royer, Toledo, OH (US)

Correspondence Address: GEORGE R. ROYER, 316 N. MICHIGAN (416), TOLEDO, OH, 43624, US

(21) Appl. No.: 10/679,444

(22) Filed: Oct. 7, 2003

(51) Int. Cl. G06F 12/14; H04L 9/32

(52) U.S. Cl. 713/183; 713/202

(57) ABSTRACT

The subject invention is an improved coding system for users to gain entry into a structured system, vehicle, or other entry means, such as an entry system being based on a process where in the entry code is a mathematical formulation or other resultant formulation of a series of numbers or letters or other similar symbols, as opposed to just a series or plurality of numbers, with the mathematical resultant or other formulation or interaction of such numbers, letters, or symbols producing the sole and ultimate access code.

### KNOWN PRIOR ART

None.

### DISCUSSION OF PRIOR ART AND BACKGROUND OF INVENTION

Coding systems are used to obtain limited or restricted access to into a system, building, motor vehicle, or other similar systems, machines, computer systems or similar systems or devices. Such coding systems are obviously maintained on a confidential or secret basis to limit access to the system to authorized individuals only and thus limiting access into such areas through a procedure using a confidential or secret code focused on a group of random numbers letters or symbols that are arbitrarily selected which are then disclosed only to the limited individuals chosen. Such systems generally, but not always, utilize a locking or access device having a plurality of keys or buttons representing individual members or letters of the alphabet or other designations. Usually the coding system contemplates the entry in some pre-selected sequence of a certain array of the numbers or symbols Access to such systems can be achieved by other methods, such as fingerprint identification, eye identification, or other similar systems. However, manual implementation of keys or button members in a designed numeric or alphanumeric coding system is still used significantly for such access purposes, as more fully discussed below.

Alternately stated, most of the alphanumeric coding systems in use today as stated above have a number of input keys to press which generally run from three to five or more in total number of buttons involved that can be pushed or otherwise manipulated to impress a series of assigned numbers or symbols for each input key into a system. The result of the series of numbers generally yield an access code in series fashion.

In this latter process, each input key will have a distinct numeric or other designation for input into the coding procedure. For example, if there are five input keys, the conventional sequence may be “one” for the first button, “two” for the second button, “three” for the third button, “four” for the forth button and “five” for the fifth button and so forth in similar progression. This latter input system, as used, has an entry base comprised of five potential code inputted numbers or less and one may generally have to press the designated input key code bottoms in a designated or pre-assigned code sequence. Thus if a code of “4-2-3-5” is assigned the authorized user must, for access purposes, press the “four” button, then the “two” button, and then the “three” and then the “five” button in that stated sequence or order to permit entry into the system or unlock a device in the foregoing example. As stated in this particular example, the authorized individual must press the keys with assigned numbers in the exact sequence of “4”-“2”-“3”-“5” for ultimate access. This latter description of a five base input key structure is only one example of many coded sequence variations and the use of a such a four numbered sequence code is only one of many variations that may be used, as more than four numbers may be used, or less. Such access as mathematically described is obvious, and is set forth as a background perspective for purposes.

In this light, as to the implementation or use of a code, some individuals simply hold the code in their memory and use vivid recall power to utilize it at a needed time. One must consider that not every person has a perfect memory at all times and almost every individual has memory lapses from time to time, particularly under stressful situations. Moreover in view of the fact that most individuals have a broad array of numbers to remember to apply to other systems or situations, under stressful situations the numbered sequence code is frequently forgotten, leasing an individual unable to access the system and sometimes stranded. Additionally those who keep notes of a code frequently misplace them, and without an adequate memory of the code access sequence, problems can be encountered as discussed. By reasons of these concerns, a more optimal code access system is needed, and the following objects are set forth accordingly.

### OBJECTS OF THE INVENTION

It is an object of the subject invention to provide an improved coding system;

Yet another object of the subject invention is to provide a simple coding system for access to a given system;

Another object of the subject invention is to provide an improved numerical code formulation;

Additionally, it is an object of the subjection invention to provide a relatively easy and efficient coded access process.

Still another object of the subjection invention is to provide a relatively efficient code system that is easier to remember and implement;

A further object of the subject invention is to provide a unique and simplistic coding system;

It is also an object of the subject invention to provide a simple code sequence conversion mechanism;

Yet another object of the subject invention is to provide improved code system;

Other objects of the subject invention will become apparent from a reading of the description taken in conjunction with the claims.

### DESCRIPTION OF DRAWINGS

1. FIG. 1 is a front elevational view of the input register device.

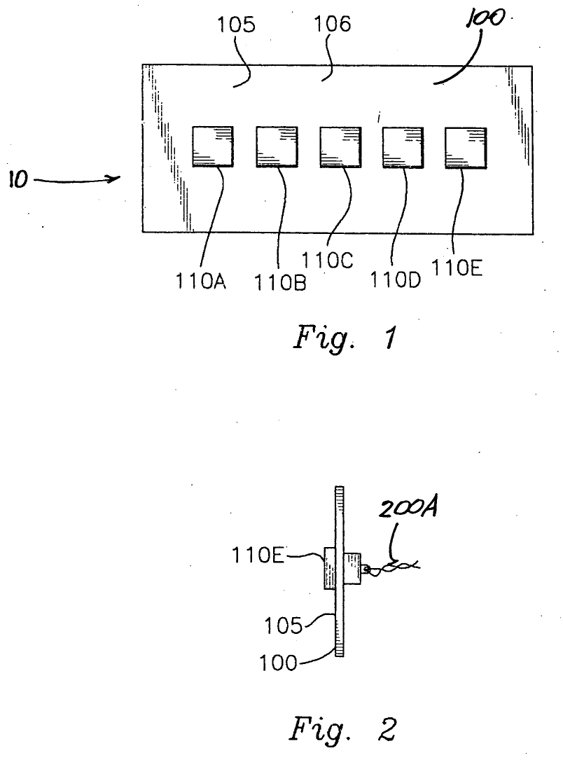

2. FIG. 2 is a side elevational view of input register device.

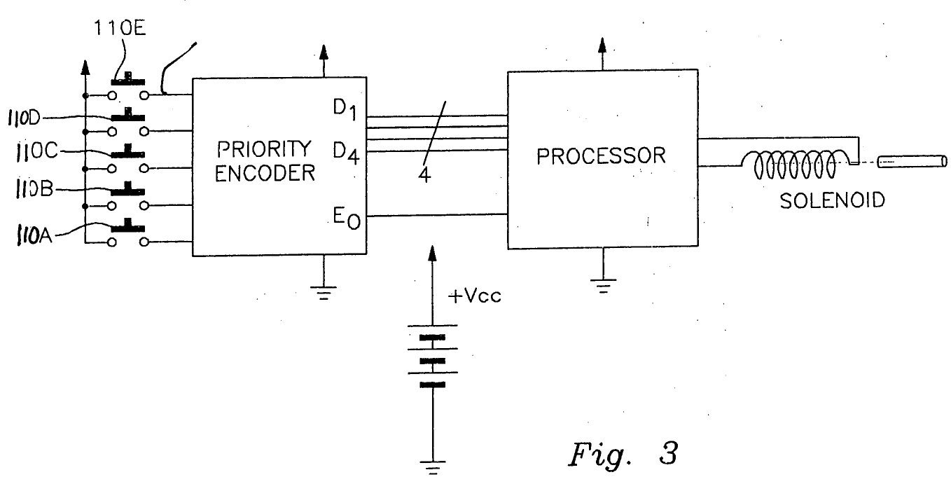

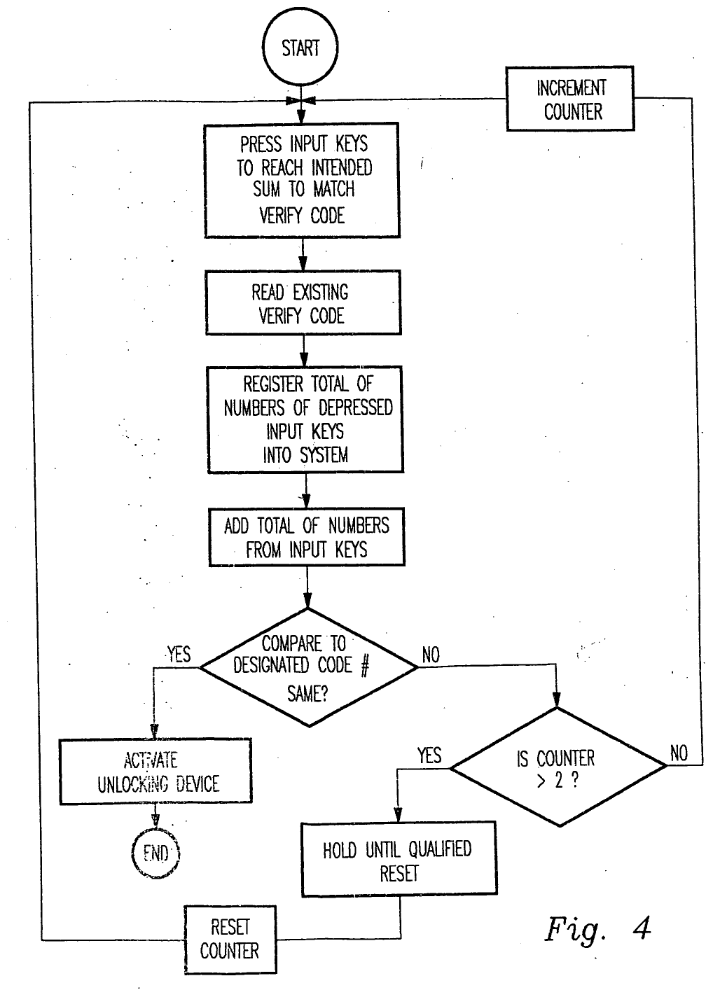

3. FIG. 3 is a schematic view of, register input circuits, this computer and locking mechanism of the circuit used in conjunction with the subject invention.

4. FIG. 4 is a flow chart diagram of the processing steps involved in the subject code processing system, demonstrating the various subcomponents of the processing system.

### DESCRIPTION OF GENERAL EMBODIMENT

In a general perspective the subject invention is a coding system based or directed towards using a single number, specifically a one, two or three digit number or larger, to access a system, such resultant number being the only code that an authorized individual must remember for accessing a system. Such a code input system is result oriented as is any code system, however the end result of the coded input will be one number, single or multiple digits, distinguished from a series of numbers that must be memorized in a usual sequence or other numerical or alphanumeric series.

For purposes of implementing the subject invention, the code mechanism will be programmed to yield the mathematical result of one number from a given set of assigned numerical values, such mathematical result being generally and preferably, as stated, a single, double or triple digit number or higher digit number. The mathematical result may be a simple summation or it may be achieved by other mathematical processes to achieve such resultant number. Moreover, as stated, a larger digit based number can be used with the subject system to achieve the entangled resultant number. More directly, the code mechanism will generally, but not essentially, have a series of buttons or input keys that can be manipulated manually, or through other input means, which could be voice directed or involve other input means. Thus, for example it is conventional to have a series of numbered input buttons or keys usually aligned with one another, each having a different input value. In some applications by reason of the workings of this system some input numbers can have the same input value. Generally, however, the first input key used may have a “1” designation for a “1” input, the second input key a “2” input, the third input key a “3” input, the forth input key a “4”, and the fifth input key a “5” input. The system however may have any different series of numbers assigned, and the numbered designations and sequences can be altered to any sequence or any number total for input into the system as may be arbitrary assigned. As stated some input keys may have the same input value. Thus, the designation of five buttons with 1, 2, 3, 4, 5 numerical values assigned is arbitrary, as more or less than five input keys may be sued for this purpose, with varying input values assigned.

In the system herein the authorized user is assigned an arbitrary number for his or her recess code, such as for example “12”. The authorized user is thus required to register a “12” for gaining access and using the system. Such authorized user can push any arrangement of input keys or buttons, with their respective assigned values to achieve a total summation from such numbered inputs for his or her assigned code number of “12” or whatever it may be. Thus, for example the user may press input keys with values of “2”, “4”, “5”, and “1” for input into the system reach a final totaled “12” at the option of authorized user. Alternately the authorized user may press the “5” key, the “3” key, and the “4” key to reach a preset total of “12”, or alternately the “5” button, the “2” button, and the “5” button again to reach a total of “12”, at the discretion of the user. Using the input keys other number arrangements may be used to reach a total of “12”. To this end the coding mechanism will be programmable to record and tabulate the separate input of the input keys and upon recording a sum equal to the authorized number code, the process will activate access to the system or device if the pre-established code number in the system is the same as the code number provided by the user seeking access in the above described process.

One question that may arise with such a simplistic system is that the combination of possible total numbers with a six digit button or higher key input system is much greater than using an input number of five keys or less. The combination and/a permutations of total arraignments encountered with using a sequence of given input members would be greater as the number of input numbers or keys are increased. Such increase with the number of input members, with differing numbered values raises geometrically the total possible output numbers as such input members increase. Thus, the particular significance to this observation is that one who is not authorized and seeks unwarranted access to the system having relatively fewer input keys may attempt to run through the whole array of code numbers possible, which may be feasible within a reasonable period of time. With the availability of only a few keys, such as three or less, without a backup safeguard, one could possibly access the systems in less than an hour simply starting at 1, then 2 and proceed up the numerical path through progressively higher numbers.

In order to obviate this latter possibility the subject system can be equipped with a cut-off system that shuts down any further access to the system after a assigned number of false numbers are entered in the code system. In this cut-off system an arbitrarily assigned number of false attempts can be programmed in the system to prevent accessing the system. The system then remains closed for a significant time period to prevent receipt of additional inputs if the correct total number is not properly entered the assigned number of attempts at entering the correct code. However if, an authorized individual inadvertently presses input keys that yield the incorrect total, the system can be programmed to receive several, but limited in number of attempts. If for example the system calls for a code of “12” total the system can allow, as an example, four more attempts but then if these next four attempts are unsuccessful, the system can be provided with a shut down system with the potential of an alarm being activated if another attempt is made. The number of false attempts before shutting down the system can be arbitrarily determined.

### DESCRIPTION OF PREFERRED EMBODIMENT

Is set in forth a preferred embodiment of the subject invention, one preferred embodiment of the subject invention will be described. The fact that one preferred embodiment is described shall not limit the scope of the subject invention as set forth in the claim.

Alternatively stated, in the following description of the subject invention, it is to be stressed that the embodiments described herein are only a few of the embodiments that are within the scope of the subject invention, and therefore such description of a few limited embodiments shall not be considered as limiting the scope of the claims annexed hereto. Moreover, it is to be stressed that the following description of the invention's application to a motor vehicle door locking system shall not be construed as limiting the scope of the invention solely to an automatic door locking system, as the scope of the subject invention my be equally applicable to any type of system, for access purposes.

In a general perspective the subject invention is a coding system based or directed towards using a single number, specifically a one, two or three digit number or larger, to access a system, such resultant number being the only code that an authorized individual must remember for accessing a system. Such a code input system is result oriented as is any code system, however the end result of the coded input will be one number, single or multiple digits, distinguished from a series of numbers that must be memorized in a usual sequence or other numerical or alphanumeric series.

For purposes of implementing the subject invention, the code mechanism will be programmed to yield the mathematical result of one number from a given set of assigned numerical values, such mathematical result being generally and preferably, as stated, a single, double or triple digit number or higher digit number. The mathematical result may be a simple summation or it may be achieved by other mathematical processes to achieve such resultant number. Moreover, as stated, a larger digit based number can be used with the subject system to achieve the entangled resultant number. More directly, the code mechanism will generally, but not essentially, have a series of buttons or input keys that can be manipulated manually, or through other input means, which could be voice directed or involve other input means. Thus, for example it is conventional to have a series of numbered input buttons or keys usually aligned with one another, each having a different input value. In some applications by reason of the workings of this system some input numbers can have the same input value. Generally, however, the first input key used may have a “1” designation for a “1” input, the second input key a “2” input, the third input key a “3” input, the forth input key a “4”, and the fifth input key a “5” input. The system however may have any different series of numbers assigned, and the numbered designations and sequences can be altered to any sequence or any number total for input into the system as may be arbitrary assigned. As stated some input keys may have the same input value. Thus, the designation of five buttons with 1, 2, 3, 4, 5 numerical values assigned is arbitrary, as more or less than five input keys may be sued for this purpose, with varying input values assigned.

In the system herein the authorized user is assigned an arbitrary number for his or her recess code, such as for example “12”. The authorized user is thus required to register a “12” for gaining access and using the system. Such authorized user can push any arrangement of input keys or buttons, with their respective assigned values to achieve a total summation from such numbered inputs for his or her assigned code number of “12” or whatever it may be. Thus, for example the user may press input keys with values of “2”, “4”, “5”, and “1” for input into the system reach a final totaled “12” at the option of authorized user. Alternately the authorized user may press the “5” key, the “3” key, and the “4” key to reach a preset total of “12”, or alternately the “5” button, the “2” button, and the “5” button again to reach a total of “12”, at the discretion of the user. Using the input keys other number arrangements may be used to reach a total of “12”. To this end the coding mechanism will be programmable to record and tabulate the separate input of the input keys and upon recording a sum equal to the authorized number code, the process will activate access to the system or device if the pre-established code number in the system is the same as the code number provided by the user seeking access in the above described process.

One question that may arise with such a simplistic system is that the combination of possible total numbers with a six digit button or higher key input system is much greater than using an input number of five keys or less. The combination and/a permutations of total arraignments encountered with using a sequence of given input members would be greater as the number of input numbers or keys are increased. Such increase with the number of input members, with differing numbered values raises geometrically the total possible output numbers as such input members increase. Thus, the particular significance to this observation is that one who is not authorized and seeks unwarranted access to the system having relatively fewer input keys may attempt to run through the whole array of code numbers possible, which may be feasible within a reasonable period of time. With the availability of only a few keys, such as three or less, without a backup safeguard, one could possibly access the systems in less than an hour simply starting at 1, then 2 and proceed up the numerical path through progressively higher numbers.

In order to obviate this latter possibility the subject system can be equipped with a cut-off system that shuts down any further access to the system after a assigned number of false numbers are entered in the code system. In this cut-off system an arbitrarily assigned number of false attempts can be programmed in the system to prevent accessing the system. The system then remains closed for a significant time period to prevent receipt of additional inputs if the correct total number is not properly entered the assigned number of attempts at entering the correct code. However if, an authorized individual inadvertently presses input keys that yield the incorrect total, the system can be programmed to receive several, but limited in number of attempts. If for example the system calls for a code of “12” total the system can allow, as an example, four more attempts but then if these next four attempts are unsuccessful, the system can be provided with a shut down system with the potential of an alarm being activated if another attempt is made. The number of false attempts before shutting down the system can be arbitrarily determined.

In light of the foregoing and more specifically the subject invention uses a process involving a numerical coding system, comprising the usage of a series of alphanumeric coded and/or numerically designated input members or symbols, which input members function when actuated to place a numerical quantitative representation into a coding system, and which system is adapted to yield a coded number or symbol, by activation of any number or arrangement of input members to yield a resultant number or other alpha numeric result by addition or other mathematical manipulation of the individual input members to reach the resulting code number for authentic other means. For purposes of the practical implementation of the subject coding process, one embodiment of the invention compromises a register having numerous input key members in the form of input key buttons that each represent numerical quantities, with the concept that any number or array of push buttons can be pressed to reach a pre-determined number by addition or other mathematical manipulation to actuate a system access or system.

Alternatively described, in the general embodiment of the subject invention is based on a system employed to access a given system such as an automobile door lock or other systems and comprises in one embodiment the following hardware and software elements:
(a) register device having on a portion of its surface manually manipulate input keys or other manually manipulate manipulated members, each having an assigned number value, letter or other symbols either marked or unmarked which can be manipulated to activate a computational process to arrive at a predetermined confidential number which leads to access of a given system, with such resultant confidential code number being achieved by adding the representative numbers of any of the input key members number to arrive at such reset end resultant number as a predetermined code or by using other mathematical manipulations or other processes to arrive at such resultant number or symbol group;
(b) independent computer hardware means interconnected with such register device having a computer software program that functions to determine if there is or is not a proper correlation between the number or symbols placed in the system by the user and the predetermined numerical or other coded data previously placed in the system;
(c) computer programming software providing algorithmic means to correlate the relationships, if any, between the coded, confidential data or number or symbol placed in the system through the register's coded number or other data in the computer system.

(d) means to activate the system or provide access to the system based on the condition of said computer programming means correlating the code input result with the predetermined code;

Additional features are incorporated in the scope of the subject invention to include means to authenticate through direct visual, scanning or computer oriented algorithmic means to provide a code for accessing to a system. Further this described general embodiment may have several specific applications or specific embodiments. As stated, this description will focus on one particular embodiment and application among the large array of possible uses or one such application as described below, is directed to a unlocking mechanism displayed on a motor vehicle door.

Attention is first addressed to the overall physically structured system as utilized herein, as seen schematically in the FIG. 1. As seen in FIG. 1, the system 10 includes a code input register device 100 comprising a base register member having a front surface 105 holding series of manual input keys 110A, 100B, 100C, 100D, and 100E, each of which input keys have a specified numerical value assigned thereto for code entry purposes. It is feasible that some of the input keys 110A, 110B, 110C, 110D, 110E, keys may have the same numerical input value since the process involves a formulation such as addition of any numbers at random by user. As more fully demonstrated in FIG. 2, such system 10 further includes a series of electrical leads 200A, 200B, 200C, 200D, 200E or other electrical impulse carrying means leading to a computer 300 as more fully represented in FIGS. 1 and 2, which computer 300 is adapted to receive the electrical signal input from each of the input keys through such electrical leads, and which computer is adapted to compute and calculate the numerical input impressed in such input keys as a total sum, on by other mathematical processing and compare the total input sum to the assigned code number, and thence send a signal to activate unlocking the access mechanism 400 or other unlocking mechanism. It must also be noted that more or less than five input keys may be used. As discussed above an alternate embodiment the system may possess a shut off mechanism to shut off the system if an improper input result is placed in the system 10 after a limited number of attempts. Moreover, as explained above the input results may be achieved by other than a summation process, or by some other process not involving mathematical computations.

Each of these sub-elements will be discussed separately as set forth below. Prior to this discussion it is important to note that the description herein is directed and focused on a mechanism for unlocking the door of a motor vehicle, not shown, and is oriented towards the hardware used in a mechanical locking system. However, it must be noted that the subject system may be used in a computer system for access thereto or other systems and is not to be limited to mechanical locking systems and may be used for unlocking any device or accessing any system on a broader perspective.

Attention is now directed more fully to FIG. 1. In FIG. 1 the mechanical code input register device system is more fully seen in detail, as can be observed in the frontal face 105 of the code input register device 100 and has a arbitrary member of such keys adapted to be manually manipulated to reach an assigned numeral value in the system into the overall coding system. In the embodiment shown in the drawings and described herein. There are five such input key members 110A, 110B, 110C, 100D, 110E however the exact number of such input keys. The exact number of such keys may vary in variations of the embodiment described herein. As seen, the input key members 110A, 110B, 110C, 110D, 110E are preferably arrangements of such key members can be used.

More specifically, as seen in FIGS. 1 and 2 in the preferred embodiment of the subject device the register device 10 has a front face 100 which is provided with a series of segmented separated manually manipulate input key members 110A, 110B, 110C, 110D, 110E . . . in the form push buttons and specifically marked with a numerical value for coding input purposes. For this purpose, each segmented input 110A, 110B, 110C, 110D, 110E . . . will have a number symbol assigned thereto, either visible or invisible or scrambled. This aspect is discussed more fully below. Each of the segmented input key members 110A, 110B, 110C, 110D, 110E . . . is a particular spatial segmented member that can be impressed to open or close a particular electrical circuit 200A, 200B, 200C, 200D, 200E, interconnected with each such input key member and computer 200, and each of which key members have an assigned number value or other symbol. Each of the electrical leads 200A, 200B, 200C, 200D, 200E feeds into the central computer 300 used to process the numeric or other information transmitted electrically, digitally, or by analog means, from each of the input key members 110A, 110B, 110C, 110D, 110E. Computer 300 has electrical interconnection through an out put circuit leading from such computer to electrically and actuate an unlocking mechanism or access mechanisms 400 adapted to unlock an automobile door lock or other appropriate access mechanisms. Again, it must be noted that the unlocking mechanisms may comprise any device to access any type of system which is mechanical, electrical or otherwise. The output circuit includes appropriate resistance means 410, power source such as battery 420, solenoid means 430, or other appropriate electric means to convert electrical output energy to mechanical energy to open lock 500 for the automobile door, not shown. Moreover, it must be noted that the output circuit may be diverted to other subsystems as needed for any type of access, and may simply be an internal computer interconnection to access another system internally or access a site on the internet.

Computer 300 may be of an appropriate genre preferably a microcomputer having minimal but specific processing capability and having means associated therewith to process and quantize, or alternately process, the electrical signal generated each of the electrical leads 200A, 200B, 200C, 200D, 200E. For this purpose each such latter electrical lead will be interconnected to electrical means, particular to each such circuit to quantize electrically the input of each circuit, or alternately stated any electrical quantizing to activate specifically calibrate resistance means, capacity means, or other electrical means to produce a quantized signal corresponding to the input value of each input key 110A, 110B, 110C, 100D, 110E . . . . More directly at the distal end or at any position separate electrical leads 200A, 200B, 200C, 200D, 200E is a priority encoder 265 electrically and otherwise structured to produce appropriate electrical signal of a value that is appropriately and corresponding related to the input value of each input key member 110A, 110B, 110C, 110D, 110E, so that each such key members will yield an electrical value for input into priority encoder 265 and computer 300, such value being that which is numerically proportionally related to all the other numerical values of assigned to each of the respective input keys 110A, 110B, 110C, 110D, 110E . . . . This electrical quantizing may be analog means or digital means. The electrical input from the respective input keys 110A, 110B, 110C, 110D, 110E will be processed through the priority encoder 265 and thence through computer 300, and if the comparison between the registered code and code data entered is the same computer 300 will activate circuit 400 to unlock the locking mechanism 500.

Other arrangements may be used on the face 20 of register device 10 for coding input purposes, so long as some coded designation or means are structured otherwise provided to accomplish the purpose or enabling the user to place discrete numerical values in the system in order. An example of one such alternative arrangement is the use of a series of numbers that are marked for purposes of scanning coded impressions as described, as push key buttons may not be necessary. This latter aspect is important to note for purposes of stressing that the inventive concepts herein are not considered to be limited to any particular type of coding means or features or symbols to be marked, as long as the system user can place into the system coded numbers or symbols or other demarcations whether alphabetic, numeric or otherwise in order to arrive at a final predetermined combination of such assigned numbers, letters or symbols. It is preferable, but not essential that computer 300 be equipped to process the following algorithmic approach or one possible mathematical or comparative approach to the ultimate coding process.
RT=Total Summation of Input=ST=_{N}S₁+_{N}S₂+_{N}S₃+_{N}S₄+_{N}S₅
or
ST=N₁S₁+N₂S₁+N₃S₃+N₄S₄+N₅S₅, or
Where ST=Total of values assigned key impressions, where N₁=number of times the first key 110A is impressed, N₂=the number of times the second key 110B is impressed, N₃=the number of times the third key 110 is impressed, and N₄ is the number of times the fourth key 110D is impressed and N₅ is the number of times the fifth key 110E is impressed. Thus if the first key 110A is impressed twice, the value N, would be “2”. If the second key is not impressed the value of N₂ would be zero, and so forth in similar manner. Thus if keys 110A is impressed twice the sum for 110A would be “2×1”=“2” for a “2” value if the numeral value of “1” is assigned to key 110A Key 110C as assigned a three value if pressed once the total value for key 110C would be “1×3”=“3”. Moreover, if key 110D is impressed twice for and having a value of “4” the total for key 4 would be “2×4”=“8”. Assume the other keys are pressed the result would equate in real numbers to RT=2×1+0×2+1×3+2×4+0×5=13 (for a code input).

The next step is to compare RT versus the code number. If the code number is 13 and RT is 13, as stated, the computer output gate will release a signal to activate circuit 400 to unlock locking mechanism 500 or access the system. More generally if ST=M (the given code as processed through computer 300, access will be granted to unlock given system.

In summary, the subject invention is a code system for obtaining access to a locking system comprising the following steps, which involves:
a. providing a plurality of numeric values in a system that can be assessed;
b. assigning a code number of one or more digits;
c. access of any of said plurality of numeric values to reach the code number.

In further summary, the subject invention is a code system for obtaining access to a system comprising the following steps:
(1) producing a plurality input symbols each of which is a given numerical value.
(2.) selecting one or more of the input symbols to arrive at a given numerical value which is the sum of the respective input symbols selected.

Yet another summary of the subject invention is as follows:
(a) first surface disposed on a portion of said register device;
(b) a plurality of keys each such key push buttons member having associated therewith an assigned number;
(c) micro switch means associated with each of such push key members, said micro switch members being activated by each of such key members;
(d) electrical lead means interfaced with said micro switch member, with such said computer;
(e) computer means that functions to determine if there is not a proper correlation between the coded number placed in the system by the user and the numerical data placed in the system.

Yet another summary of the invention is a coding system for accessing a system comprising the following steps:
(a) a hardware member having a plurality of input members adapted to be manipulated, each of said input members having an assigned numerical value associated therewith proving input data;
(b) computer means interconnected electrically to said hardware members, said computer means adapted to said process input numerical data;
(c) means to calculate a total of the input members to reach a predetermined number;
(d) means to compare said predetermined number in such computer with the number calculated from said input numbers and open access to a system if said predetermined number is the same number as said calculated number.

Further, the subject invention is a coding system for accessing a system comprising:
(a) a hardware member having a plurality on input members adapted to be manipulated, each of said input members having an assigned numerical value associated therewith for proving input data into the system;
(b) computer means interconnected to said hardware member, said computer means adapted to said process input numerical data.

1. A code system for obtaining access to a locking system comprising the following steps, which involves addressing a service of:
a. a providing a plurality of numeric values in a system;
b. assigning a code number of one or more digits;
c. accessing of any of said plurality of numeric values mathematically to reach the said code number through computer processing steps.

2. A code system for obtaining access to a system comprising the following steps:
(a) providing a code number in a computer system;
(b) providing a plurality input symbols each of which is a given numerical value;
(c) selecting one or more of said input symbols to arrive mathematically at a given numerical value which is the sum of the respective input symbols selected;
(d) processing said sum of the respective input symbols in said computer system to arrive mathematically at a sum of said input signals and comparing in said computer system said sum to see said code number to ascertain if said code members is the same as said sum;
(e) providing access to open a system based on a positive comparative identity between said sum and said code number.

3. A code process for accessing a system comprising:
(a) first surface disposed on a portion of said register device;
(b) a plurality of keys each said key push buttons member having associated therewith an assigned number;
(c) micro switch means associated with each of said push key members, said micro switch members being activated by each of said key members;
(d) electrical lead means interfaced with said micro switch member, and with said computer;
(e) computer means that functions to determine if there is not a proper correlation between the coded number placed in the system by the user and the numerical data placed in the system.

4. A coding system for accessing a system comprising the following steps:
(a) a hardware member having a plurality of input members adapted to be manipulated, each of said input members having an assigned numerical value associated therewith proving input data;
(b) computer means interconnected electrically to said hardware members, said computer means adapted to said process input numerical data;
(c) means to calculate a total of the input members to reach a predetermined number;
(d) means to compare said predetermined number in such computer with the number calculated from said input numbers and open access to a system if said predetermined number is the same number as said calculated number.

5. A coding apparatus for accessing a system comprising:
(a) a hardware member having a plurality on input members adapted to be manipulated, each of said input members having an assigned numerical value associated therewith proving input data;
(b) first computer means interconnected to said hardware member, said computer means adapted to hold a code number;
(c) second computer means interconnected to said first computer means to receive and process said input date to from said hardware member and compare said input members to said code number.
